(19) United States
(12) Patent Application Publication
(10) Pub. No.: US 2011/0026459 A1
(43) Pub. Date: Feb. 3, 2011

(54) METHOD AND APPARATUS FOR CLOSED-LOOP TRANSFORMED CODEBOOK BASED ANTENNA BEAMFORMING

(75) Inventors: Jiann-An Tsai, Plano, TX (US); Zhouyue Pi, Allen, TX (US)

Correspondence Address: Docket Clerk, P.O. Drawer 800889, Dallas, TX, 75380, US

(73) Assignee: Samsung Electronics Co., Ltd., Suwon-si (KR)

(21) Appl. No.: 12/757,598

(22) Filed: Apr. 9, 2010

Related U.S. Application Data
(60) Provisional application No. 61/271,898, filed on Jul. 28, 2009.
(60) Provisional application No. 61/237,256, filed on Aug. 26, 2009.

(51) Int. Cl. H04W 40/00

(52) U.S. Cl. 370/328

(57) ABSTRACT

A wireless communications network including a plurality of base stations is provided. Each one of the base stations wirelessly communicates with a plurality of subscriber stations. At least one of the plurality of base stations includes a receiver configured to receive a precoding vector index (PVI) from a subscriber station. The least one of the plurality of base stations also includes a controller configured to update a transmit covariance matrix using the precoding vector index, and transform a codebook using the updated transmit covariance matrix. The least one of the plurality of base stations further includes a transmitter configured to perform transmit beamforming to the subscriber station using the transformed codebook.

### CROSS-REFERENCE TO RELATED APPLICATION(S) AND CLAIM OF PRIORITY

The present application is related to U.S. Provisional Patent Application Ser. No. 61/271,898, filed Jul. 28, 2009, entitled “METHOD AND APPARATUS OF CONTROL SIGNALING DESIGN FOR CLOSED-LOOP TRANSFORMED CODEBOOK BASED ANTENNA BEAMFORMING IN OFDM WIRELESS SYSTEMS”. Provisional Patent Application No. 61/271,898 is assigned to the assignee of the present application and is hereby incorporated by reference into the present application as if fully set forth herein. The present application hereby claims priority under 35 U.S.C. §119(e) to U.S. Provisional Patent Application No. 61/271,898.

The present application also is related to U.S. Provisional Patent Application No. 61/237,256, filed Aug. 26, 2009, entitled “METHOD AND APPARATUS OF CLOSED-LOOP TRANSMIT ANTENNA BEAM TRACKING USING ADAPTIVE TRANSFORMATION CODEBOOK IN OFDM WIRELESS SYSTEMS”. Provisional Patent Application No. 61/237,256 is assigned to the assignee of the present application and is hereby incorporated by reference into the present application as if fully set forth herein. The present application hereby claims priority under 35 U.S.C. §119(e) to U.S. Provisional Patent Application No. 61/237,256.

### TECHNICAL FIELD OF THE INVENTION

The present application relates generally to wireless communication systems and, more specifically, to beamforming in wireless communication systems.

### BACKGROUND OF THE INVENTION

Transmit beamforming in wireless systems can be performed in either a closed-loop or an open-loop manner. An open-loop system is well suited for Time Division Duplexing (TDD) systems. An open-loop system does not require channel information feedback.

As a result, less overhead is required. However, the disadvantage of an open-loop system is that the system needs to constantly conduct phase calibration in order to compensate for the phase difference between the transmission and reception Radio Frequency (RF) chains among the multiple transmit antennas. Another disadvantage of an open-loop system is that the system requires a constant uplink phase reference such as uplink pilots. This requirement could lead to an excessive feedback overhead. The process of phase calibration is generally costly and sensitive to radio channel environment.

A closed-loop system, on the other hand, does not require phase calibration process. However, a closed-loop system does require channel feedback to the transmitter, which results in additional overhead. Furthermore, a closed-loop system is also sensitive to feedback channel error due to feedback delay or fast channel variation. Typically, Frequency Division Duplexing (FDD) systems employ closed-loop transmit beamforming schemes. However, a closed-loop scheme also can be applied to TDD systems.

### SUMMARY OF THE INVENTION

A wireless communications network including a plurality of base stations is provided. Each one of the base stations wirelessly communicates with a plurality of subscriber stations. At least one of the plurality of base stations includes a receiver configured to receive a preceding vector index (PVI) from a subscriber station. The least one of the plurality of base stations also includes a controller configured to update a transmit covariance matrix using the precoding vector index, and transform a codebook using the updated transmit covariance matrix. The least one of the plurality of base stations further includes a transmitter configured to perform transmit beamforming to the subscriber station using the transformed codebook.

A base station is provided. The base station includes a receiver configured to receive a preceding vector index (PVI) from a subscriber station. The base station also includes a controller configured to update a transmit covariance matrix using the preceding vector index, and transform a codebook using the updated transmit covariance matrix. The base station further includes a transmitter configured to perform transmit beamforming to the subscriber station using the transformed codebook.

A method of operating a base station is provided. The method includes receiving a precoding vector index (PVI) from a subscriber station, updating a transmit covariance matrix using the precoding vector index, transforming a codebook using the updated transmit covariance matrix, and performing transmit beamforming to the subscriber station using the transformed codebook.

A subscriber station is provided. The subscriber station includes a receiver configured to receive a pilot or channel sounding signal from a base station. The subscriber station also includes a controller configured to determine a precoding vector index (PVI) based at least partly upon the received pilot or channel sounding signal. The subscriber station further includes a transmitter configured to transmit the precoding vector index to the base station.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network that transmits messages in the uplink according to the principles of this disclosure;

FIG. 2 illustrates an exemplary base station in greater detail according to one embodiment of this disclosure;

FIG. 3 illustrates an exemplary wireless subscriber station in greater detail according to one embodiment of this disclosure;

FIG. 4 illustrates a diagram of a base station in communication with a plurality of mobile stations according to an embodiment of this disclosure;

FIG. 5 illustrates a 4×4 MIMO system according to an embodiment of this disclosure;

FIG. 6 illustrates a Spatial Division Multiple Access (SDMA) scheme according to an embodiment of this disclosure;

FIG. 7 illustrates a quantization table used to quantize information fed back to a base station according to an embodiment of this disclosure;

FIG. 8 illustrates a method of tracking-based closed-loop transformed codebook based transmit beamforming (CL-TCTB) according to an embodiment of this disclosure;

FIG. 9 illustrates a method of enhancing the convergence speed of tracking-based closed-loop transformed codebook based transmit beamforming (CL-TCTB) according to an embodiment of this disclosure;

FIG. 10 illustrates a method of tracking-based closed-loop transformed codebook based transmit beamforming (CL-TCTB) at a mobile station according to an embodiment of this disclosure;

FIG. 11 illustrates a method of tracking-based closed-loop transformed codebook based transmit beamforming (CL-TCTB) at a base station according to an embodiment of this disclosure;

FIG. 12 illustrates a method of tracking-based closed-loop transformed codebook based transmit beamforming (CL-TCTB) at a mobile station according to another embodiment of this disclosure;

FIG. 13 illustrates a method of tracking-based closed-loop transformed codebook based transmit beamforming (CL-TCTB) at a mobile station according to another embodiment of this disclosure;

FIG. 14 illustrates a method of tracking-based closed-loop transformed codebook based transmit beamforming (CL-TCTB) at a base station according to another embodiment of this disclosure;

FIG. 15 illustrates a method of enhancing the convergence speed of tracking-based closed-loop transformed codebook based transmit beamforming (CL-TCTB) at a mobile station according to another embodiment of this disclosure;

FIG. 16 illustrates a method of enhancing the convergence speed of tracking-based closed-loop transformed codebook based transmit beamforming (CL-TCTB) at a base station according to another embodiment of this disclosure;

FIG. 17 illustrates tables used by a base station to signal various values to a mobile station according to embodiments of this disclosure; and

FIG. 18 illustrates a binary pseudorandom sequence generator according to an embodiment of this disclosure.

### DETAILED DESCRIPTION OF THE INVENTION

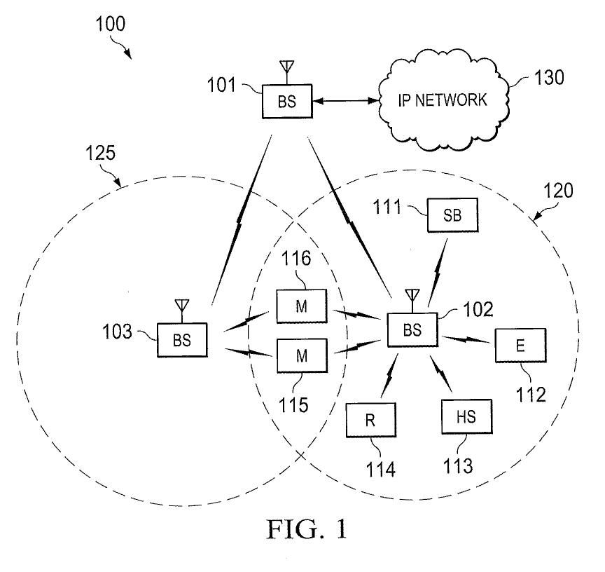

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

FIG. 1 illustrates exemplary wireless network 100, which transmits messages according to the principles of this disclosure. In the illustrated embodiment, wireless network 100 includes base station (BS) 101, base station (BS) 102, base station (BS) 103, and other similar base stations (not shown).

Base station 101 is in communication with Internet 130 or a similar IP-based network (not shown).

Base station 102 provides wireless broadband access to Internet 130 to a first plurality of subscriber stations within coverage area 120 of base station 102. The first plurality of subscriber stations includes subscriber station 111, which may be located in a small business (SB), subscriber station 112, which may be located in an enterprise (E), subscriber station 113, which may be located in a WiFi hotspot (HS), subscriber station 114, which may be located in a first residence (R), subscriber station 115, which may be located in a second residence (R), and subscriber station 116, which may be a mobile device (M), such as a cell phone, a wireless laptop, a wireless PDA, or the like.

Base station 103 provides wireless broadband access to Internet 130 to a second plurality of subscriber stations within coverage area 125 of base station 103. The second plurality of subscriber stations includes subscriber station 115 and subscriber station 116. In an exemplary embodiment, base stations 101-103 may communicate with each other and with subscriber stations 111-116 using OFDM or OFDMA techniques.

While only six subscriber stations are depicted in FIG. 1, it is understood that wireless network 100 may provide wireless broadband access to additional subscriber stations. It is noted that subscriber station 115 and subscriber station 116 are located on the edges of both coverage area 120 and coverage area 125. Subscriber station 115 and subscriber station 116 each communicate with both base station 102 and base station 103 and may be said to be operating in handoff mode, as known to those of skill in the art.

Subscriber stations 111-116 may access voice, data, video, video conferencing, and/or other broadband services via Internet 130. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer (PC), a laptop computer, a gateway, or another device.

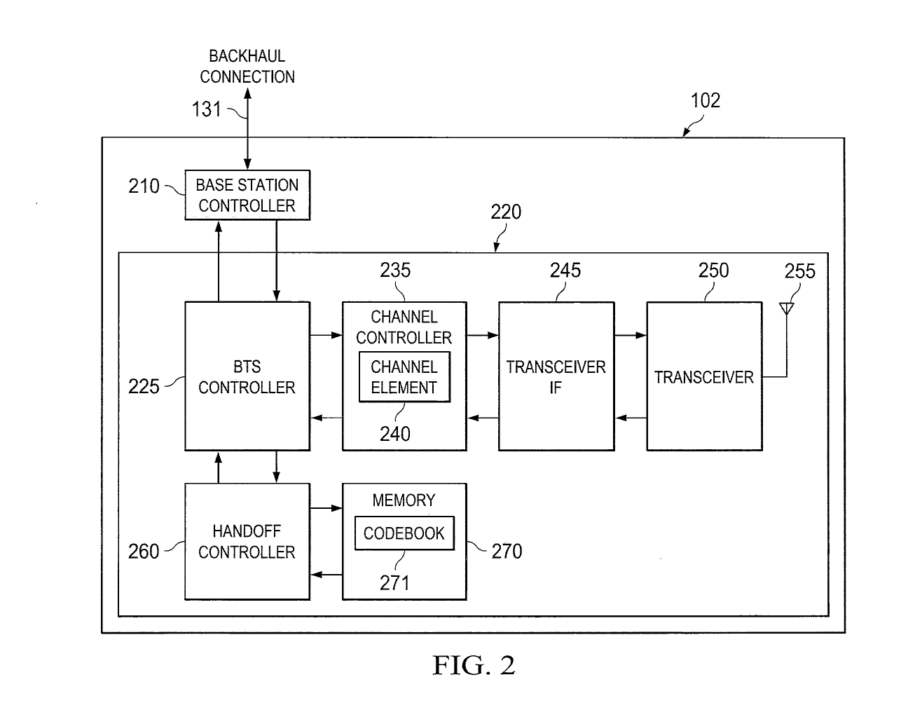

FIG. 2 illustrates an exemplary base station in greater detail according to one embodiment of this disclosure. The embodiment of base station (BS) 102 illustrated in FIG. 2 is for illustration only. Other embodiments of the BS 102 could be used without departing from the scope of this disclosure.

BS 102 comprises a base station controller (BSC) 210 and a base transceiver subsystem (BTS) 220. A base station controller is a device that manages wireless communications resources, including base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces, RF transmitters and RF receivers. For the purpose of simplicity and clarity in explaining the operation of this disclosure, the base transceiver subsystem and the base station controller associated with each base transceiver subsystem are collectively represented by BS 101, BS 102 and BS 103, respectively.

BSC 210 manages the resources in a cell site including BTS 220. BTS 220 comprises a BTS controller 225, a channel controller 235, a transceiver interface (IF) 245, an RF transceiver unit 250, and an antenna array 255. Channel controller 235 comprises a plurality of channel elements including an exemplary channel element 240. BTS 220 also comprises a handoff controller 260 and a memory 270. The embodiment of handoff controller 260 and memory 270 included within BTS 220 is for illustration only. Handoff controller 260 and memory 270 can be located in other portions of BS 102 without departing from the scope of this disclosure.

BTS controller 225 comprises processing circuitry and memory capable of executing an operating program that communicates with BSC 210 and controls the overall operation of BTS 220. Under normal conditions, BTS controller 225 directs the operation of channel controller 235, which contains a number of channel elements including channel element 240 that perform bi-directional communications in the forward channels and the reverse channels. A forward channel refers to a channel in which signals are transmitted from the base station to the mobile station (also referred to as DOWNLINK communications). A reverse channel refers to a channel in which signals are transmitted from the mobile station to the base station (also referred to as UPLINK communications). In an embodiment of this disclosure, the channel elements communicate according to an OFDMA protocol with the mobile stations in cell 120. Transceiver IF 245 transfers the bi-directional channel signals between channel controller 240 and RF transceiver unit 250. The embodiment of RF transceiver unit 250 as a single device is for illustration only. RF transceiver unit 250 can comprise separate transmitter and receiver devices without departing from the scope of this disclosure.

Antenna array 255 transmits forward channel signals received from RF transceiver unit 250 to mobile stations in the coverage area of BS 102. Antenna array 255 also sends to transceiver 250 reverse channel signals received from mobile stations in the coverage area of BS 102. In some embodiments of this disclosure, antenna array 255 is a multi-sector antenna, such as a three-sector antenna in which each antenna sector is responsible for transmitting and receiving in a 120° arc of coverage area. Additionally, RF transceiver 250 may contain an antenna selection unit to select among different antennas in antenna array 255 during transmit and receive operations.

According to some embodiments of this disclosure, BTS controller 225 is configured to store a codebook 271 in memory 270. The codebook 271 is used by BS 102 to perform beamforming with a mobile station. Memory 270 can be any computer readable medium. For example, the memory 270 can be any electronic, magnetic, electromagnetic, optical, electro-optical, electro-mechanical, and/or other physical device that can contain, store, communicate, propagate, or transmit a computer program, software, firmware, or data for use by the microprocessor or other computer-related system or method. A part of memory 270 comprises a random access memory (RAM), and another part of memory 270 comprises a Flash memory that acts as a read-only memory (ROM).

BSC 210 is configured to maintain communications with BS 101, BS 102 and BS 103. BS 102 communicates with BS 101 and BS 103 via a wireless connection. In some embodiments, the wireless connection is a wire-line connection.

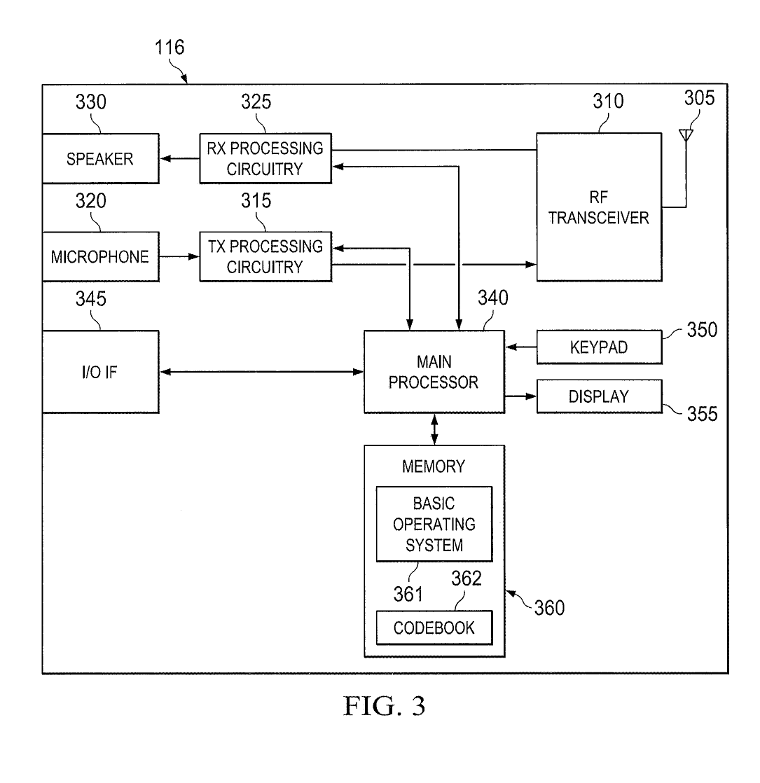

FIG. 3 illustrates an exemplary wireless subscriber station in greater detail according to one embodiment of this disclosure. The embodiment of wireless subscriber station (SS) 116 illustrated in FIG. 3 is for illustration only. Other embodiments of the wireless SS 116 could be used without departing from the scope of this disclosure.

Wireless SS 116 comprises an antenna 305, a radio frequency (RF) transceiver 310, a transmit (TX) processing circuitry 315, a microphone 320, and a receive (RX) processing circuitry 325. SS 116 also comprises a speaker 330, a main processor 340, an input/output (I/O) interface (IF) 345, a keypad 350, a display 355, and a memory 360. Memory 360 further comprises a basic operating system (OS) program 361 and a codebook 362 used by SS 116 to perform beamforming with a base station.

Radio frequency (RF) transceiver 310 receives from antenna 305 an incoming RF signal transmitted by a base station of wireless network 100. Radio frequency (RF) transceiver 310 down-converts the incoming RF signal to produce an intermediate frequency (IF) or a baseband signal. The IF or baseband signal is sent to receiver (RX) processing circuitry 325 that produces a processed baseband signal by filtering, decoding, and/or digitizing the baseband or IF signal. Receiver (RX) processing circuitry 325 transmits the processed baseband signal to speaker 330 (i.e., voice data) or main processor 340 for further processing (e.g., web browsing).

Transmitter (TX) processing circuitry 315 receives analog or digital voice data from microphone 320 or other outgoing baseband data (e.g., web data, e-mail, interactive video game data) from main processor 340. Transmitter (TX) processing circuitry 315 encodes, multiplexes, and/or digitizes the outgoing baseband data to produce a processed baseband or IF signal. Radio frequency (RF) transceiver 310 receives the outgoing processed baseband or IF signal from transmitter (TX) processing circuitry 315. Radio frequency (RF) transceiver 310 up-converts the baseband or IF signal to a radio frequency (RF) signal that is transmitted via antenna 305.

In some embodiments of this disclosure, main processor 340 is a microprocessor or microcontroller. Memory 360 is coupled to main processor 340. According to some embodiments of this disclosure, a part of memory 360 comprises a random access memory (RAM) and another part of memory 360 comprises a Flash memory that acts as a read-only memory (ROM).

Main processor 340 executes a basic operating system (OS) program 361 stored in memory 360 in order to control the overall operation of wireless SS 116. In one such operation, main processor 340 controls the reception of forward channel signals and the transmission of reverse channel signals by radio frequency (RF) transceiver 310, receiver (RX) processing circuitry 325, and transmitter (TX) processing circuitry 315 in accordance with well-known principles.

Main processor 340 is capable of executing other processes and programs resident in memory 360. Main processor 340 can move data into or out of memory 360 as required by an executing process. Main processor 340 also is coupled to I/O interface 345. I/O interface 345 provides SS 116 with the ability to connect to other devices such as laptop computers and handheld computers. I/O interface 345 is the communication path between these accessories and main controller 340.

Main processor 340 also is coupled to keypad 350 and display unit 355. The operator of SS 116 uses keypad 350 to enter data into SS 116. Display 355 may be a liquid crystal display (LCD) capable of rendering text and/or at least limited graphics from web sites. Alternate embodiments may use other types of displays.

Descriptions of closed-loop transmit beamforming schemes based on a codebook design can be found, for example, in D. Love, J. Heath, and T. Strohmer, “Grassmannian beamforming for multiple-input multiple-output wireless systems”, IEEE Trans. on Information Theory, October 2003, and V. Raghavan, A. M. Sayeed, and N. Boston, “Near-optimal codebook constructions for limited feedback beamforming in correlated MIMO channels with few antennas”, IEEE 2006 International Symposium on Information Theory. Both references are hereby incorporated by reference into this disclosure as if fully set forth herein.

Closed-loop codebook-based transmit beamforming can be used for a scenario where a base station forms a transmit antenna beam toward a single user or simultaneously toward multiple users at the same time and at a certain frequency. A description of such a system can be found, for example, in Quentin H. Spencer, Christian B. Peel, A. Lee Swindlehurst, Martin Harrdt, “An Introduction to the Multi-User MIMO Downlink”, IEEE Communication Magazine, October, 2004, which is hereby incorporated by reference into this disclosure as if fully set forth herein.

A codebook is a set of pre-determined antenna beams that are known to mobile stations. A codebook based pre-coding MIMO can provide significant spectral efficiency gain in the downlink closed-loop MIMO. In the IEEE 802.16e and 3GPP LTE standards, a 4 TX limited feedback based closed-loop MIMO configuration is supported. In IEEE 802.16m and 3GPP LTE Advanced standards, in order to provide peak spectral efficiency, 8 TX antennas configurations are proposed as a prominent precoding closed-loop MIMO downlink system. Descriptions of such systems can be found, for example, in 3GPP TS36.211 “Evolved Universal Terrestrial Radio Access (E-UTRA): Physical Channel and Modulation”, which is hereby incorporated by reference into this disclosure as if fully set forth herein.

To eliminate the need for the phase calibration process in cases where channel sounding signals or common pilot signals (or midamble) are note used for data demodulation purpose, a closed-loop transformed codebook based transmit beamforming is utilized. A description of such a system can be found, for example, in IEEE C802.16m-08/1345r2, “Transformation method for codebook based precoding”, November 2008, which is hereby incorporated by reference into this disclosure as if fully set forth herein. The transformed codebook method utilizes the channel correlation information to enhance the performance of the standard codebook especially in the highly correlated channels as well as to eliminate the need of phase calibration among multiple transmit antennas. Typically, the channel correlation information is based on second order statistics and, thus, changes very slowly, which is similar to long term channel effects such as shadowing and path loss. As a result, the feedback overhead and computation complexity using correlation information are very small.

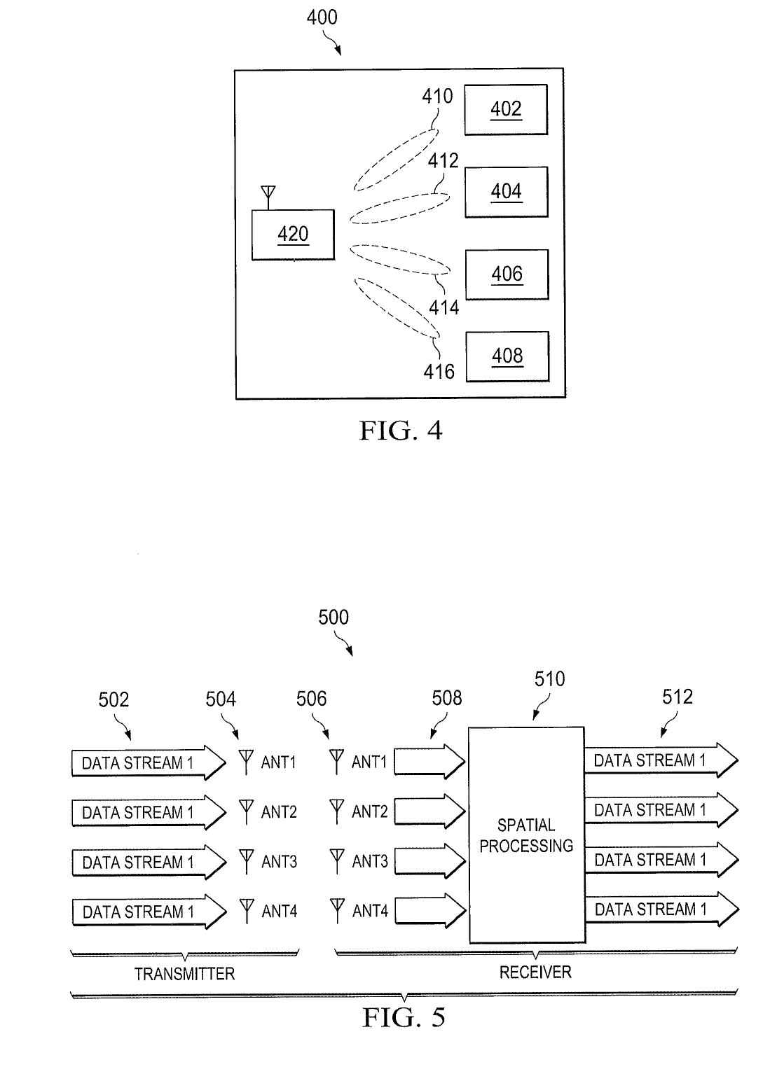

FIG. 4 illustrates a diagram 400 of a base station 420 in communication with a plurality of mobile stations 402, 404, 406, and 408 according to an embodiment of this disclosure.

As shown in FIG. 4, base station 420 simultaneously communicates with multiple of mobile stations through the use of multiple antenna beams, each antenna beam is formed toward its intended mobile station at the same time and same frequency. Base station 420 and mobile stations 402, 404, 406, and 408 are employing multiple antennas for transmission and reception of radio wave signals. The radio wave signals can be Orthogonal Frequency Division Multiplexing (OFDM) signals.

In this embodiment, base station 420 performs simultaneous beamforming through a plurality of transmitters to each mobile station. For instance, base station 420 transmits data to mobile station 402 through a beamformed signal 410, data to mobile station 404 through a beamformed signal 412, data to mobile station 406 through a beamformed signal 414, and data to mobile station 408 through a beamformed signal 416. In some embodiments of this disclosure, base station 420 is capable of simultaneously beamforming to the mobile stations 402, 404, 406, and 408. In some embodiments, each beamformed signal is formed toward its intended mobile station at the same time and the same frequency. For the purpose of clarity, the communication from a base station to a mobile station may also be referred to known as downlink communication and the communication from a mobile station to a base station may be referred to as uplink communication.

Base station 420 and mobile stations 402, 404, 406, and 408 employ multiple antennas for transmitting and receiving wireless signals. It is understood that the wireless signals may be radio wave signals, and the wireless signals may use any transmission scheme known to one skilled in the art, including an Orthogonal Frequency Division Multiplexing (OFDM) transmission scheme.

Mobile stations 402, 404, 406, and 408 may be any device that is capable receiving wireless signals. Examples of mobile stations 402, 404, 406, and 408 include, but are not limited to, a personal data assistant (PDA), laptop, mobile telephone, handheld device, or any other device that is capable of receiving the beamformed transmissions.

The OFDM transmission scheme is used to multiplex data in the frequency domain. Modulation symbols are carried on frequency sub-carriers. The quadrature amplitude modulation (QAM) modulated symbols are serial-to-parallel converted and input to the inverse fast Fourier transform (IFFT). At the output of the IFFT, N time-domain samples are obtained. Here N refers to the IFFT/fast Fourier transform (FFT) size used by the OFDM system. The signal after IFFT is parallel-to-serial converted and a cyclic prefix (CP) is added to the signal sequence. CP is added to each OFDM symbol to avoid or mitigate the impact due to multipath fading. The resulting sequence of samples is referred to as an OFDM symbol with a CP. At the receiver side, assuming that perfect time and frequency synchronization are achieved, the receiver first removes the CP, and the signal is serial-to-parallel converted before being fed into the FFT. The output of the FFT is parallel-to-serial converted, and the resulting QAM modulation symbols are input to the QAM demodulator.

The total bandwidth in an OFDM system is divided into narrowband frequency units called subcarriers. The number of subcarriers is equal to the FFT/IFFT size N used in the system. In general, the number of subcarriers used for data is less than N because some subcarriers at the edge of the frequency spectrum are reserved as guard subcarriers. In general, no information is transmitted on guard subcarriers.

Because each OFDM symbol has finite duration in time domain, the sub-carriers overlap with each other in frequency domain. However, the orthogonality is maintained at the sampling frequency assuming the transmitter and receiver have perfect frequency synchronization. In the case of frequency offset due to imperfect frequency synchronization or high mobility, the orthogonality of the sub-carriers at sampling frequencies is destroyed, resulting in inter-carrier-interference (ICI).

The use of multiple transmit antennas and multiple receive antennas at both a base station and a single mobile station to improve the capacity and reliability of a wireless communication channel is known as a Single User Multiple Input Multiple Output (SU-MIMO) system. A MIMO system promises linear increase in capacity with K where K is the minimum of number of transmit (M) and receive antennas (N) (i.e., K=min(M,N)). A MIMO system can be implemented with the schemes of spatial multiplexing, a transmit/receive beamforming, or transmit/receive diversity.

FIG. 5 illustrates a 4×4 MIMO system 500 according to an embodiment of this disclosure.

In this example, four different data streams 502 are transmitted separately using four transmit antennas 504. The transmitted signals are received at four receive antennas 506 and interpreted as received signals 508. Some form of spatial signal processing 510 is performed on the received signals 508 in order to recover four data streams 512.

An example of spatial signal processing is Vertical-Bell Laboratories Layered Space-Time (V-BLAST), which uses the successive interference cancellation principle to recover the transmitted data streams. Other variants of MIMO schemes include schemes that perform some kind of space-time coding across the transmit antennas (e.g., Diagonal Bell Laboratories Layered Space-Time (D-BLAST)). In addition, MIMO can be implemented with a transmit/receive diversity scheme and a transmit/receive beamforming scheme to improve the link reliability or system capacity in wireless communication systems.

The MIMO channel estimation consists of estimating the channel gain and phase information for links from each of the transmit antennas to each of the receive antennas. Therefore, the channel response “H” for N×M MIMO system consists of an N×M matrix, as shown in Equation 1 below:

$$H = [ \begin{matrix}{a}_{11} & {a}_{12} & … & {a}_{1 M} \\ {a}_{21} & {a}_{22} & … & {a}_{2 M} \\ ⋮ & ⋮ & … & ⋮ \\ {a}_{N 1} & {a}_{M 2} & … & {a}_{N M}\end{matrix} ] . \qquad [ Eqn . 1 ]$$

In Equation 1, the MIMO channel response is represented by H and a_{NM} represents the channel gain from transmit antenna N to receive antenna M. In order to enable the estimations of the elements of the MIMO channel matrix, separate pilots may be transmitted from each of the transmit antennas.

As an extension of SU-MIMO, multi-user MIMO (MU-MIMO) is a communication scenario where a base station with multiple transmit antennas can simultaneously communicate with multiple mobile stations through the use of multi-user beamforming schemes such as Spatial Division Multiple Access (SDMA) to improve the capacity and reliability of a wireless communication channel.

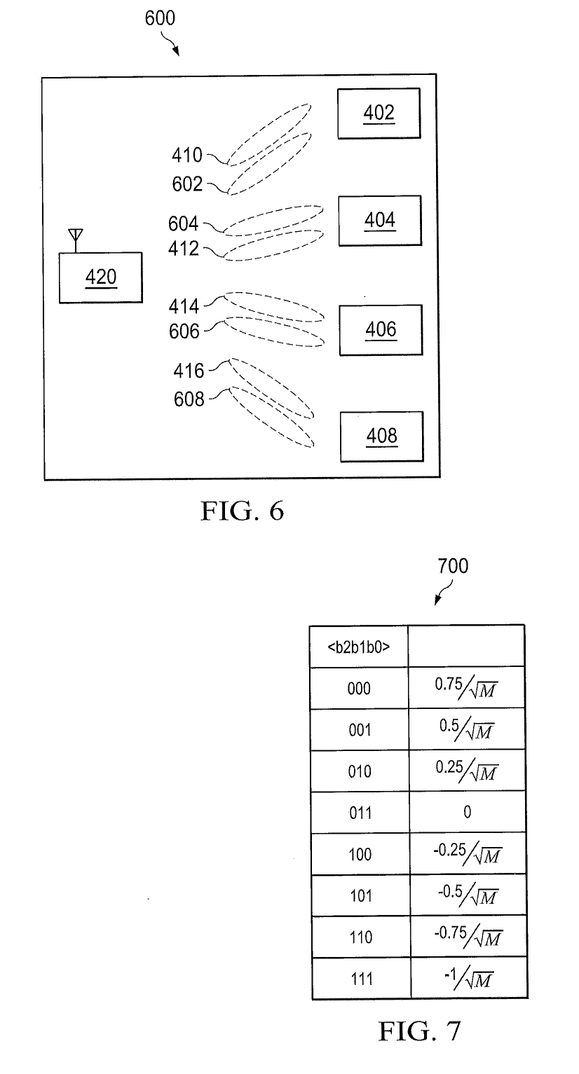

FIG. 6 illustrates an SDMA scheme according to an embodiment of this disclosure.

As shown in FIG. 6, base station 420 is equipped with 8 transmit antennas while mobile stations 402, 404, 406, and 408 are each equipped two antennas. In this example, base station 420 has eight transmit antennas. Each of the transmit antennas transmits one of beamformed signals 410, 602, 604, 412, 414, 606, 416, and 608. In this example, mobile station 402 receives beamformed transmissions 410 and 602, mobile station 404 receives beamformed transmissions 604 and 412, mobile station 406 receives beamformed transmissions 606 and 414, and mobile station 408 receives beamformed transmissions 608 and 416.

Since base station 420 has eight transmit antenna beams (each antenna beams one stream of data streams), eight streams of beamformed data can be formed at base station 420. Each mobile station can potentially receive up to 2 streams (beams) of data in this example. If each of the mobile stations 402, 404, 406, and 408 was limited to receive only a single stream (beam) of data, instead of multiple streams simultaneously, this would be multi-user beamforming (i.e., MU-BF).

Closed-loop fixed codebook transmit beamforming has been employed in many wireless system such as WIMAX or 3GPP LTE. Descriptions of such systems can be found, for example, in 3GPP TS36.211 “Evolved Universal Terrestrial Radio Access (E-UTRA): Physical Channel and Modulation” and IEEE 802.16e “Part 16: Air Interface for Fixed and Mobile Broadband Wireless Access Systems”. Both references are hereby incorporated by reference into this disclosure as if fully set forth herein. In a closed loop codebook beamforming system, a transmitter sends a pilot signal or channel sounding signal to a receiver, and the receiver measures the channel information and calculates the best codeword within a codebook that best matches the observed channel. The best codeword information is then fed back to the transmitter. The transmitter then uses the best codeword information for transmit antenna beamforming.

The downside to fixed codebooks is two fold. First, the channel quantization error is limited by the codebook size. Namely, the smaller a codebook size, the larger a quantization error. For example, if a codebook was designed for uncorrelated antenna wireless channels, such a codebook would not be optimal for correlated antenna wireless channels due to the limited codebook size. Second, a closed-loop fixed codebook based transmit beamforming would not work properly without phase calibration among transmit antennas in a scenario where channel sounding signals or common pilot signals (or midamble) is only used for channel quality estimation or the best codeword estimation, while a dedicated pilot signal is used separately for data demodulation purpose.

To enhance the performance of a closed-loop fixed codebook transmit beamforming scheme with limited feedback as well as to eliminate the need of phase calibration, a transformed codebook based transmit beamforming scheme can be utilized. Descriptions of such systems can be found, for example, in G. J. Foschini and M. J. Gans, “On limits of wireless communications in a fading environment when using multiple antennas”, Wireless Personal Communication, vol. 6., pp 311-335, March 1998. and L. Liu and H. Jafarkhani, “Novel transmit beamforming schemes for time-selective fading multiantenna systems” IEEE Trans. on Signal Processing, Dec. 2006. Both references are hereby incorporated by reference into this disclosure as if fully set forth herein.

A transformed codebook method utilizes the long-term channel correlation matrix information to enhance the performance of the standard codebook especially in the highly correlated channel as well as to eliminate the need for phase calibration among multiple transmit antennas. Typically, the channel correlation matrix information is based on the second order statistics, and thus, it changes very slowly, which is similar to long term channel effects such as shadowing and path loss. Thus, the feedback overhead and computation complexity of correlation information are very small.

Although some embodiments of this disclosure are described in terms a single receive antenna at a receiver and multiple transmit antenna at a transmitter, one of ordinary skill in the art would recognize that the embodiments of this disclosure can also be applied to multiple receive antennas at a receiver. In the context of cellular wireless systems, the receiver can be a mobile station or handheld device while the transmitter is a base station as shown in FIG. 1. The received signal model at a mobile station can be expressed as shown in Equation 2 below:

y=Hws+n, [Eqn. 2]

where y is the received vector, and H is the channel matrix of size 1 by M. M is the number of transmit antenna at a base station. n is the complex additive white Gaussian noise with variance N₀, S is the modulated signal, and W is the transmit beamforming vector of size M by 1. The transmit channel covariance matrix R is simply defined as shown in Equation 3 below:

R=E{HH^{H}}, [Eqn. 3]

where (*)^{H} is Hermitian operation. In the context of OFDM-based wireless systems, the transmit channel covariance matrix can be further defined as shown in Equation 4 below:

Rᵢⱼ=HᵢⱼHᵢⱼ^{H}, [Eqn. 4]

where Hᵢⱼ is the channel vector at the i-th OFDM symbol and j-th subcarrier. The long-term average transmit channel covariance matrix, \hat{R}, can be expressed as shown in Equation 5 below:

$$\hat{R} = {\sum }_{i = 1}^{{N}_{S}} {\sum }_{j = 1}^{{N}_{F}} {H}_{i j} {H}_{i j}^{H} , \qquad [ Eqn . 5 ]$$

where N_{S} and N_{F} is the number of OFDM symbol and the number of subcarriers, respectively, used over an average period.

The long-term average transmit channel covariance matrix \hat{R} is typically normalized by minimizing the dynamic range of the channel covariance matrix, which is denoted as <R>. That is, <R>=\hat{R}/norm(\hat{R}). Furthermore, the normalized <R> is an M×M matrix and can be further expressed as shown in Equation 6 below:

$$〈 R 〉 = {\sum }_{k = 1}^{K} {λ}_{k} {u}_{k} {u}_{k}^{H} , \qquad [ Eqn . 6 ]$$

where K is the number of eigen modes (or eigen values), and λₖ is the k-th eigenvalue and is in descending order, namely, λ₁ is the largest eigenvalue. u₁ is the largest eigenvector, and uₖ is the k-th eigenvector.

To ensure a transformed codebook based transmit beamforming works properly, the long-term average <R> of Equation 5 or Equation 6 is estimated or calculated at a receiver through the use of common pilot signals or channel sounding signals from a transmitter. The information of <R> estimated at a receiver is fed back to a transmitter. The transmitter then uses the information of <R> to transform the fixed codebook or the base codebook, which is known to both the transmitter and the receiver. Assume a base codebook or a fixed codebook is P, and the codebook size is D. P=[p₁p₂ . . . p_{D}] is a matrix with size of M×D. pⱼ is the j-th precoding vector within a base codebook. The transformed codebook W is an M×D matrix and can be expressed as shown in Equation 7 below:

W=<R>P. [Eqn. 7]

It is noted that <R> is the long-term averaged and normalized channel matrix as described in the above section. The transformed codebook W can be calculated at both a transmitter and a receiver. It is used by a transmitter for transmit beamforming purpose. The transmit antenna weight W used in Equation 2 is derived from W in conjunction with the best antenna beam information dₘₐₓ. The best antenna beam information is calculated and estimated at a receiver and is also fed back to a transmitter. The best antenna beam information dₘₐₓ can be derived as shown in Equation 8 below:

$${d}_{max} = {arg max}_{d \leq D} {w}_{d}^{H} H . \qquad [ Eqn . 8 ]$$

In one embodiment of this disclosure, the feedback overhead of quantized <R> is proportional to the reported channel rank information. For example, if a mobile station reports rank-1 transmission, only the information of λ₁ and u₁ needs to be reported back to a base station. In this case, a mobile station needs to quantize λ₁ and u₁ and report λ₁ and u₁ back to a base station. Similarly, if a mobile station reports the rank-K transmission, only the quantized information of λ₁ . . . λ_{K} and u₁ . . . u_{K} needs to reported back to a base station.

In another embodiment of this disclosure, the feedback overhead of quantized <R> is further reduced. Specifically, only the quantized information u₁ is reported back to a base station for rank-1 transmission. Since u₁ is a complex vector of size 1×M, the total number of quantized elements of u₁ is 2M, which includes both real and imaginary components for each element. If the number of quantized bits is B for each real or imaginary component of each element, the total number of quantization bits for u₁ is 2×M×B, which is also the feedback overhead needed to report to a base station.

In a further embodiment of this disclosure, the feedback overhead is further reduced by only reporting the non-first element of u₁ if the first element of u₁ is normalized and is used as a reference for the rest of the elements, i.e., if u₁ is expressed as shown in Equation 9 below:

u₁=[u₁₁u₁₂ . . . u_{1M}]^{T}, [Eqn. 9]

where (*)^{T} is a transpose operation. The first element of u₁ is u₁₁. In this embodiment, the total number of quantization bits is reduced from 2×M×B to 2×(M−1)×B. The quantized <R> can be shown in Equation 10 below:

<R>=λ₁u₁u₁^{H}. [Eqn. 10]

FIG. 7 illustrates a quantization table 700 used to quantize information fed back to a base station according to an embodiment of this disclosure.

As shown in FIG. 7, a quantization table 700 is used to quantize u₁. In a particular embodiment, a 3-bit quantization table (B=3), namely <b2b1b0>, such as table 700, is used to quantize the real and imaginary components of elements in u₁, where b2 is the most significant bit, while b0 is the least significant bit.

In another embodiment of this disclosure, quantization table 700 is used to quantize u₁ . . . u_{K}. In a particular embodiment, a 3-bit quantization table (B=3), such as table 700, is used to quantize the real and imaginary components of elements in u₁ . . . u_{K}.

In one embodiment of this disclosure, the feedback overhead can be further reduced by tracking <R>. In a further embodiment of this disclosure, the tracking and estimating of <R> occurs simultaneously at both a base station and a mobile station, instead of the mobile station reporting the quantization version of u₁ or u₁ . . . u_{K} to the base station.

In a particular embodiment, the simultaneous tracking and estimating of <R> at both a base station and a mobile station utilizes the information of the best reported antenna beam index or the reported precoding vector index (PVI), which is derived from a mobile station.

In another embodiment of this disclosure, a random vector is used to enhance the tracking and estimating of <R> at both a base station and a mobile station. In this embodiment, the random vector is known to both the base station and the mobile station. The generation of the random vector is based on the same random seed that is used at both the mobile station and the base station. The tracking and estimating of <R> is denoted as <<\hat{R}>>, which is simultaneously tracked by a base station and a mobile station.

In a particular embodiment, <<\hat{R}>> at a base station can be tracked as function of a forgetting factor, a random factor, and a reported PVI index from a mobile station as shown in Equation 11 below:

<<\hat{R}>>=f(α,β,dₘₐₓ,p_{d}_{ₘₐₓ},v_{random}), [Eqn. 11]

where α is the forgetting factor, which is designed to track the mobility of a channel, and β is the random factor, which is designed to avoid the bias effect on the estimation of <<\hat{R}>>. p_{d}_{ₘₐₓ} is the best PVI reported from a base station. v_{random} is the random vector, which is simultaneously generated at both a base station and a mobile station in a synchronized manner.

In another particular embodiment of this disclosure, <<\hat{R}>> can be specifically tracked and calculated at both a base station and mobile station as shown in Equation 12 below:

<<\hat{R}>>[T]=α<<\hat{R}>>[T−1]+(1−α)p_{d}_{ₘₐₓ}^{H}[T]+βv_{random}[T]v_{random}^{H}[T],T=1, 2, 3 . . . , [Eqn. 12]

where T=1, 2, 3 . . . is the updated tracking timing index.

In a further embodiment of this disclosure, <<\hat{R}>>[T] in Equation 12 is normalized before applying the base codebook P in order to generate the transform codebook W in Equation 7. The normalized <<R>>[T] is denoted as <<R>>[T] where <<R>>[T]=<<R>>[T]/norm(<<\hat{R}>>[T]).

In a further embodiment of this disclosure, the updated period (cycle) for p_{d}_{ₘₐₓ} and v_{random} in Equation 11 or Equation 12 can be the same or different.

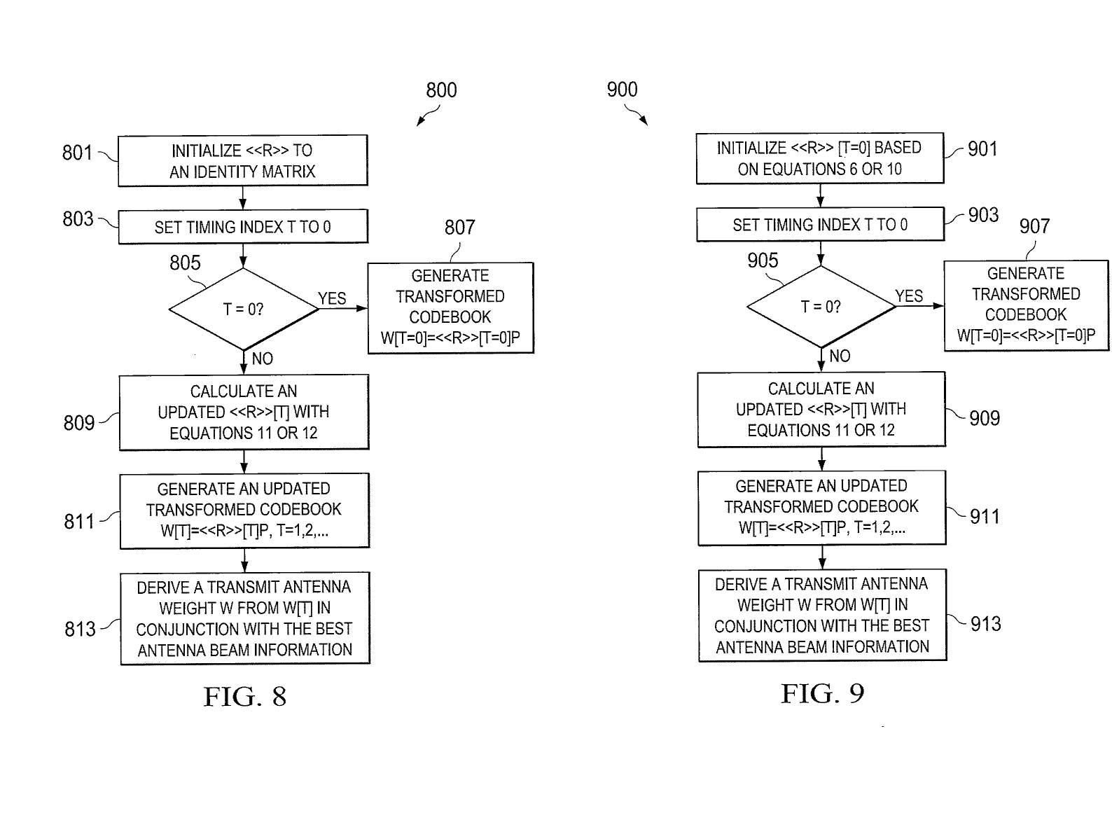

FIG. 8 illustrates a method 800 of tracking-based closed-loop transformed codebook based transmit beamforming (CL-TCTB) according to an embodiment of this disclosure.

As shown in FIG. 8, a base station or a mobile station initializes <<R>> to an identity matrix (block 801) and sets a timing index T to zero (block 803). If the timing index T equals zero (block 805), the base station or mobile station generates a transformed codebook in which W[T=0]=<<R>>[T=0]P (block 807). If the timing index T does not equal zero (block 805), the base station or mobile station calculates an updated <<R>>[T], T=1, 2, . . . using Equations 11 or 12 (block 809) and generates an updated transformed codebook in which W[T]=<<R>>[T]P, T=1, 2, . . . (block 811). The base station or mobile station then derives a transmit antenna weight w from W[T] in conjunction with the best antenna beam information dₘₐₓ (block 813).

FIG. 9 illustrates a method 900 of enhancing the convergence speed of tracking-based closed-loop transformed codebook based transmit beamforming (CL-TCTB) according to an embodiment of this disclosure.

In this embodiment, the initiation process of <<R>> is improved to enhance the convergence speed of tracking-based CL-TCTB. The improved initialization of <<R>> is based on the quantization version of u₁ or u₁ . . . u_{K}. As shown in FIG. 9, a base station or a mobile station initializes <<R>>[T=0] based on Equations 6 or 10 using u₁ or u₁ . . . u_{K} (block 901) and sets a timing index T to zero (block 903). If the timing index T equals zero (block 905), the base station or mobile station generates a transformed codebook in which W[T=0]=<<R>>[T=0]P (block 907). If the timing index T does not equal zero (block 905), the base station or mobile station calculates an updated <<R>>[1], T=1, 2, . . . using Equations 11 or 12 (block 909) and generates an updated transformed codebook in which W[T]=<<R>>[T]P, T=1, 2, . . . (block 911). The base station or mobile station then derives a transmit antenna weight w from W[T] in conjunction with the best antenna beam information dₘₐₓ (block 913).

In one embodiment, the tracking based CL-TCTB simultaneously tracks and estimates <<R>> at both a base station and a mobile station utilizing the information of the best reported antenna beam index or the reported PVI, which is derived at the mobile station. In addition to reporting the best PVI index to a base station, in a further embodiment of this disclosure, a mobile station reports the random vector index that will be used at both the base station and the mobile station to enhance the tracking and estimating of <<R>>.

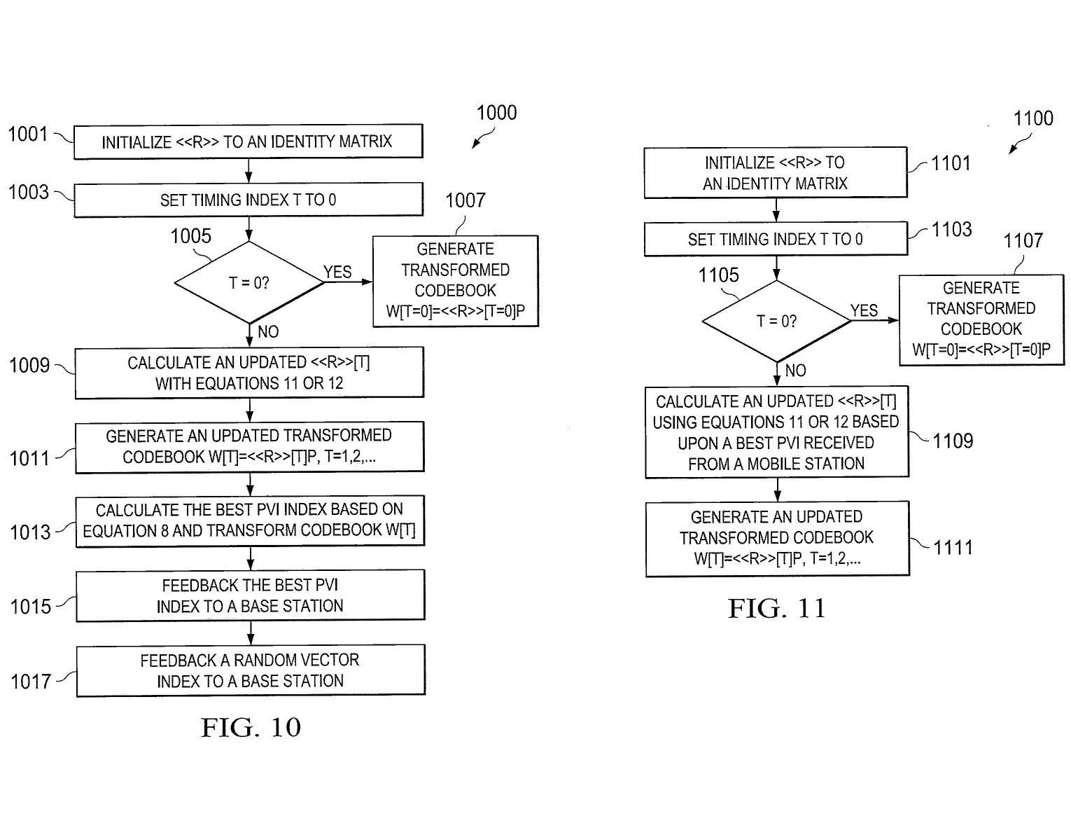

FIG. 10 illustrates a method 1000 of tracking-based closed-loop transformed codebook based transmit beamforming (CL-TCTB) at a mobile station according to an embodiment of this disclosure.

As shown in FIG. 10, a mobile station initializes <<R>> to an identity matrix (block 1001) and sets a timing index T to zero (block 1003). If the timing index T equals zero (block 1005), the mobile station generates a transformed codebook in which W[T=0]=<<R>>[T=0]P (block 1007). If the timing index T does not equal zero (block 1005), the mobile station calculates an updated <<R>>[T], T=1, 2, . . . using Equations 11 or 12 (block 1009) and generates an updated transformed codebook in which W[T]=<<R>>[T]P, T=1, 2, . . . (block 1011). The mobile station then calculates the best PVI p_{d}_{ₘₐₓ} based on Equation 8 and transform codebook W[T] (block 1013). The mobile station feeds back the best PVI p_{d}_{ₘₐₓ} to a base station (block 1015). The mobile station also feeds back the random vector index to the base station (block 1017).

FIG. 11 illustrates a method 1100 of tracking-based closed-loop transformed codebook based transmit beamforming (CL-TCTB) at a base station according to an embodiment of this disclosure.

As shown in FIG. 11, a base station initializes <<R>> to an identity matrix (block 1101) and sets a timing index T to zero (block 1103). If the timing index T equals zero (block 1105), the base station generates an updated transformed codebook in which W[T=0]=<<R>>[T=0]P (block 1107). If the timing index T does not equal zero (block 1105), the base station calculates an updated <<R>>[T], T=1, 2, . . . using Equations 11 or 12 based upon a best PVI p_{d}_{ₘₐₓ} received from a mobile station (block 1109) and generates a transformed codebook in which W[T]=<<R>>[T]P, T=1, 2, . . . (block 1111).

In another embodiment of this disclosure, the initiation process of <<R>> is improved to enhance the convergence speed of tracking based CL-TCTB at a mobile station. The improved initialization of <<R>> is based on the quantization version of u₁ or u₁ . . . u_{K}.

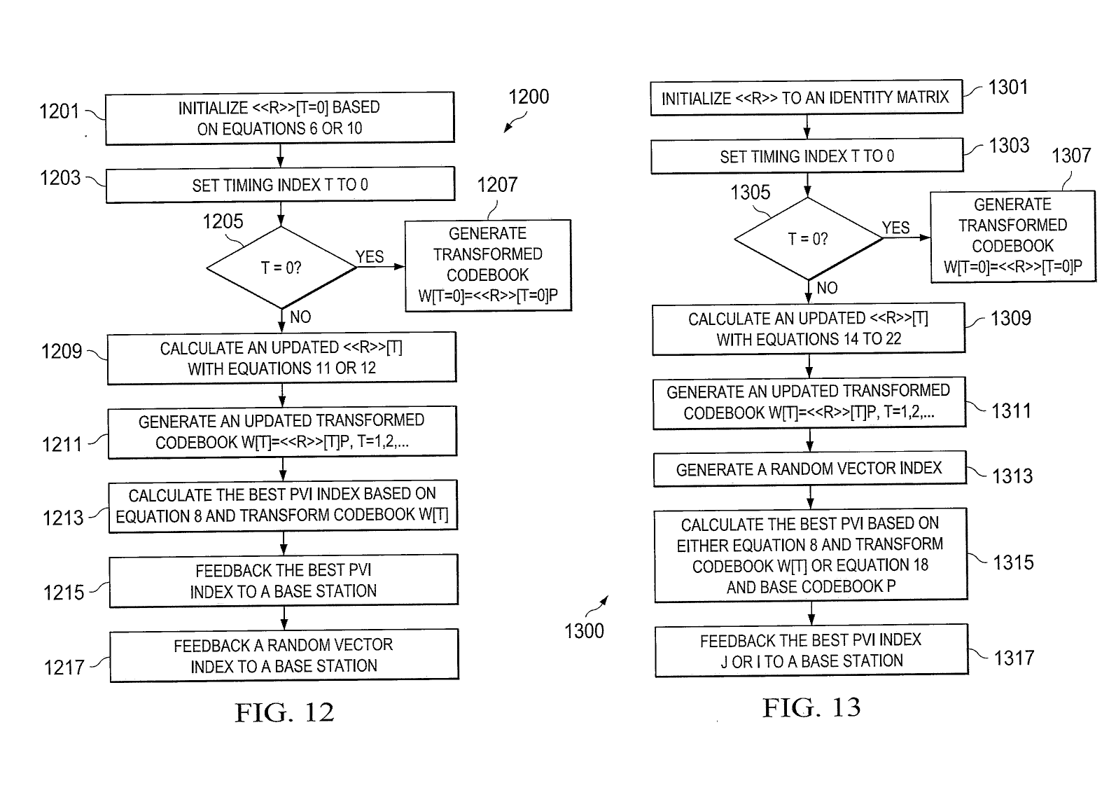

FIG. 12 illustrates a method 1200 of tracking-based closed-loop transformed codebook based transmit beamforming (CL-TCTB) at a mobile station according to another embodiment of this disclosure.

As shown in FIG. 12, a mobile station initializes R>>[T=0] based on Equations 6 or 10 using u₁ or u₁ . . . u_{K} (block 1201) and sets a timing index T to zero (block 1203). If the timing index T equals zero (block 1205), the mobile station generates a transformed codebook in which W[T=0]=<<R>>[T=0]P (block 1207). If the timing index T does not equal zero (block 1205), the mobile station calculates an updated <<R>>[T], T=1, 2, . . . using Equations 11 or 12 (block 1209) and generates an updated transformed codebook in which W[T]=<<R>>[T]P, T=1, 2, . . . (block 1211). The mobile station then calculates the best PVI p_{d}_{ₘₐₓ} based on Equation 8 and transforms codebook W[T] (block 1213). The mobile station feeds back the best PVI p_{d}_{ₘₐₓ} to a base station (block 1215). The mobile station also feeds back the random vector index to the base station (block 1217).

In another embodiment of this disclosure, the parameter value of α (the forgetting factor and) and β (the random factor) in Equation 11 and Equation 12 are signaled in order to enhance the tracking performance. For example, as a mobile station is under a high-mobility channel condition, a base station can signal the mobile station to use a smaller value of α. In another embodiment of this disclosure, the updated period (cycle) for p_{d}_{ₘₐₓ} and v_{randbm} are signaled separately. Namely, the updated period (cycle) for p_{d}_{ₘₐₓ} and v_{random} can be the same or can be different.

In another embodiment of this disclosure, the estimating of <<R>> is simultaneously tracked by a base station and a mobile station as function of a forgetting factor, a random factor, a channel quality indication (CQI) or SINR (signal to interference plus noise) ratio and a best antenna beam information d_{maX} from a mobile station, which is based on transformation codebook W using Equation 8, as shown in Equation 13 below:

<<\hat{R}>>=f(α,β,dₘₐₓ,wⱼ,γ,v_{random}) [Eqn. 13]

where α is the forgetting factor, which is designed to track the mobility of mobile channel, and β is the random factor, which is designed to avoid bias estimation of <<\hat{R}>>. γ is the parameter related SINR or CQI value, wⱼ is the best transmit antenna weight at a base station, which is also the best reported precoding vector from a mobile station, based on the transformed codebook W. v_{random} is a complex random vector, which is simultaneously generated at both a base station and a mobile station in a synchronized manner. v_{random} is designed to avoid bias estimation of <<\hat{R}>>.

In another embodiment of this disclosure, <<\hat{R}>>[T] at the time index T, which is applied to a base codebook to form a transformation codebook, is specifically and simultaneously tracked and calculated at both a base station and a mobile station as shown in Equation 14 below:

<<\hat{R}>>[T]=α<<\hat{R}>>[T−1]+(1−α)wⱼ[T]wⱼ^{H}[T]γ+βv_{random}[T]v_{random}^{H}[T] [Eqn. 14]

where T=1, 2, 3 . . . is the updated tracking timing index. With the special case of γ=1, <<\hat{R}>>[1], which is applied to a base codebook to form a transformation codebook in Equation 14, can be simplified as shown in Equation 15 below:

<<\hat{R}>>[T]=α<<\hat{R}>>[T−1]+(1−α)wⱼ[T]wⱼ^{H}[T]+βv_{random}[T]v_{random}^{H}[T]. [Eqn. 15]

In another embodiment of this disclosure, <<\hat{R}>>[T] at the time index T, which is applied to a base codebook to form a transformation codebook, is specifically and simultaneously tracked and calculated at both a base station and a mobile station as shown in Equation 16 below:

<<\hat{R}>>[T]=(1−α)<<\hat{R}>>[T−1]+αwⱼ[T]wⱼ^{H}[T]γ+βv_{random}[T]v_{random}^{H}[T]. [Eqn. 16]

With the special case of γ=1, <<\hat{R}>>[T], which is applied to a base codebook to form a transformation codebook in the Equation 16, can be simplified as shown in Equation 17 below:

<<\hat{R}>>[T]=(1−α)<<\hat{R}>>[T−1]+αwⱼ[T]wⱼ^{H}[T]+βv_{random}[T]v_{random}^{H}[T]. [Eqn. 17]

In another embodiment of this disclosure, <<\hat{R}>>[T] in Equations 14, 15, 16, and 17 are first normalized before applying the base codebook P in order to generate the transform codebook W of Equation 7.

In another embodiment of this disclosure, the estimation of <<\hat{R}>>, which is applied to a base codebook to form a transformation codebook, is simultaneously tracked by a base station and a mobile station as function of a forgetting factor, a random factor, and the best antenna beam information dₘₐₓ from a mobile station, which is based on a fixed or base codebook P using Equation 18 below:

<<\hat{R}>>=f(α,β,dₘₐₓ,pᵢ,γ,v_{random}) [Eqn. 18]

where the best antenna beam information dₘₐₓ can be obtained by Equation 19 below:

$${d}_{max} = {arg max}_{k \leq D} {p}_{k}^{H} H , \qquad [ Eqn . 19 ]$$

where pᵢ is the best transmit antenna weight at a base station, which is also the best reported precoding vector from a mobile station, based on a fixed or base codebook P.

Based on Equation 17, in another embodiment of this disclosure, <<\hat{R}>>[T] at the time index T, which is applied to a base codebook to form a transformation codebook, is specifically and simultaneously tracked and calculated at both a base station and a mobile station as shown in Equation 20 below:

<<\hat{R}>>[T]=α<<\hat{R}>>[T−1]+(1−α)pᵢ[T]pᵢ^{H}[T]γ+βv_{random}[T]v_{random}^{H}[T]. [Eqn. 20]

With the special case of γ=1, <<\hat{R}>>[T], which is applied to a base codebook to form a transformation codebook in Equation 20, can be simplified as shown in Equation 21 below:

<<\hat{R}>>[T]=α<<\hat{R}>>[T−1]+(1−α)pᵢ[T]pᵢ^{H}[T]+βv_{random}[T]v_{random}^{H}[T]. [Eqn. 21]

In another embodiment of this disclosure, <<\hat{R}>>[T] at the time index T, which is applied to a base codebook to form a transformation codebook, is specifically and simultaneously tracked and calculated at both a base station and a mobile station as shown in Equation 22 below:

<<\hat{R}>>[T]=(1−α)<<\hat{R}>>[T−1]+αpᵢ[T]pᵢ^{H}[T]γ+βv_{random}[T]v_{random}^{H}[T]. [Eqn. 22]

With the special case of γ=1, <<\hat{R}>>[T], which is applied to a base codebook to form a transformation codebook in Equation 22, is simplified as shown in Equation 23 below:

<<\hat{R}>>[T]=(1−α)<<\hat{R}>>[T−1]+αpᵢ[T]pᵢ^{H}[T]+βv_{random}[T]v_{random}^{H}[T]. [Eqn. 23]

In another embodiment of this disclosure, <<\hat{R}>>[T] in Equations 20, 21, 22, and 23 are first normalized before applying the base codebook P in order to generate the transform codebook W in Equation 7.

In another embodiment of this disclosure, the updated period (cycle) for pᵢ, wⱼ and v_{random} in Equations 14, 15, 16, 17, 20, 21, 22, and/or 23 can be the same or different.

FIG. 13 illustrates a method 1300 of tracking-based closed-loop transformed codebook based transmit beamforming (CL-TCTB) at a mobile station according to another embodiment of this disclosure.

This embodiment relates to a CL-TCTB system with tracking based methods for <<\hat{R}>>[T] in Equations 14, 15, 16, 17, 18, 20, 21, 22, and/or 23, which is simultaneously tracked at both a base station and a mobile station.

As shown in FIG. 13, a mobile station initializes <<R>> to an identity matrix (block 1301) and sets a timing index T to zero (block 1303). If the timing index T equals zero (block 1305), the mobile station generates a transformed codebook in which W[T=0]=<<R>>[T=0]P (block 1307). If the timing index T does not equal zero (block 1305), the mobile station calculates an updated <<R>>[T], T=1, 2, . . . using Equations 14 to 22 (block 1309) and generates an updated transformed codebook in which W[T]=<<R>>[T]P, T=1, 2, . . . (block 1311). The mobile station also generates a random vector v_{random} (block 1313). The mobile station then calculates the best PVI p_{d}_{ₘₐₓ} based on either Equation 8 and transform codebook W[T] or Equation 18 and base codebook P (block 1315). The mobile station also feeds back the best PVI j or i to a base station (block 1317).

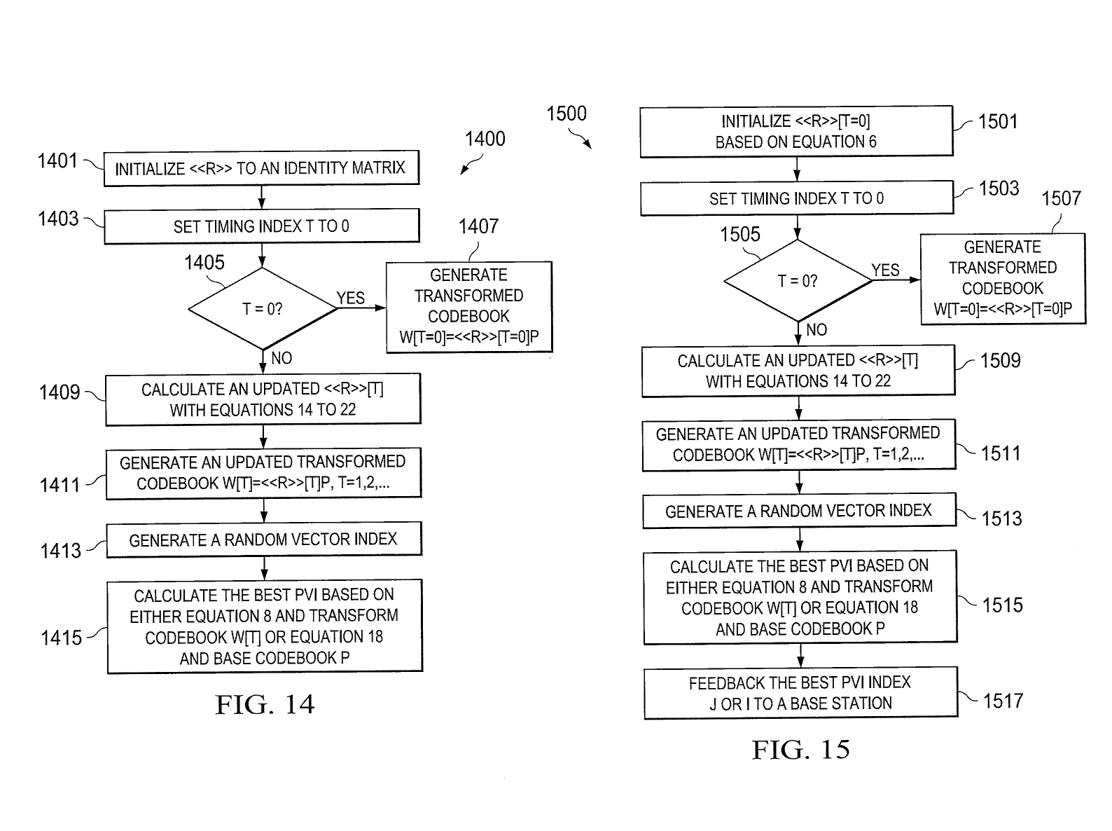

FIG. 14 illustrates a method 1400 of tracking-based closed-loop transformed codebook based transmit beamforming (CL-TCTB) at a base station according to another embodiment of this disclosure.

As shown in FIG. 14, a base station initializes <<R>> to an identity matrix (block 1401) and sets a timing index T to zero (block 1403). If the timing index T equals zero (block 1405), the base station generates a transformed codebook in which W[T=0]=<<R>>[T=0]P (block 1407). If the timing index T does not equal zero (block 1405), the base station calculates an updated <<R>>[T], T=1, 2, . . . using Equations 14 to 22 (block 1409) and generates an updated transformed codebook in which W[T]=<<R>>[T]P, T=1, 2, . . . (block 1411). The base station also generates a random vector v_{random} (block 1413). The base station then calculates the best PVI p_{d}_{ₘₐₓ} based on either Equation 8 and transform codebook W[T] or Equation 18 and base codebook P (block 1415).

FIG. 15 illustrates a method 1500 of enhancing the convergence speed of tracking-based closed-loop transformed codebook based transmit beamforming (CL-TCTB) at a mobile station according to another embodiment of this disclosure.

In another embodiment of this disclosure, the initiation process of <<R>>[T] in Equations 14, 15, 16, 17, 18, 20, 21, 22, and 23 is improved to enhance the convergence speed of tracking based CL-TCTB at a base station and a mobile station. The improved initialization of <<R>>[T] is based on the quantization version of u₁ or u₁ . . . u_{K}.

As shown in FIG. 15, a mobile station initializes <<R>>[T=0] based on Equation 6 using u₁ or u₁ . . . u_{K} (block 1501) and sets a timing index T to zero (block 1503). If the timing index T equals zero (block 1505), the mobile station generates a transformed codebook in which W[T=0]=<<R>>[T=0]P (block 1507). If the timing index T does not equal zero (block 1505), the mobile station calculates an updated <<R>>[T], T=1, 2, . . . using Equations 14 to 22 (block 1509) and generates an updated transformed codebook in which W[T]=<<R>>[T]P, T=1, 2, . . . (block 1511). The mobile station also generates a random vector v_{random} (block 1513). The mobile station then calculates the best PVI p_{d}_{ₘₐₓ} based on either Equation 8 and transform codebook W[T] or Equation 18 and base codebook P (block 1515). The mobile station also feeds back the best PVI j or i to a base station (block 1517).

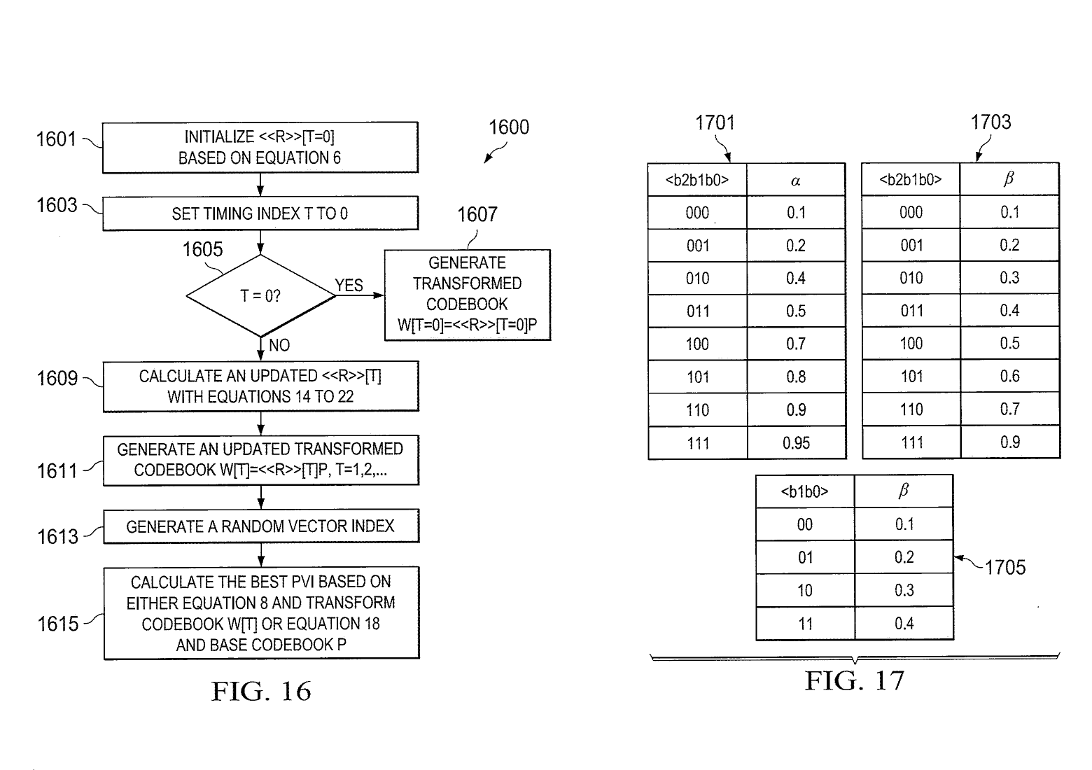

FIG. 16 illustrates a method 1600 of enhancing the convergence speed of tracking-based closed-loop transformed codebook based transmit beamforming (CL-TCTB) at a base station according to another embodiment of this disclosure.

As shown in FIG. 16, a base station initializes <<R>>[T=0] based on Equation 6 using u₁ or u₁ . . . u_{K} received from a mobile station (block 1601) and sets a timing index T to zero (block 1603). If the timing index T equals zero (block 1605), the base station generates a transformed codebook in which W[T=0]<<R>>[T=0]P (block 1607). If the timing index T does not equal zero (block 1605), the base station calculates an updated <<R>>[T], T=1, 2, . . . using Equations 14 to 22 (block 1609) and generates an updated transformed codebook in which W[T]=<<R>>[T]P, T=1, 2, . . . (block 1611). The base station also generates a random vector v_{random} (block 1613). The base station then calculates the best PVI p_{d}_{ₘₐₓ} based on either Equation 8 and transform codebook W[T] or Equation 18 and base codebook P (block 1615).

For the purpose of notation simplification, in the following sections, wⱼ and v_{random} in Equations 14, 15, 16, 17, 18, 20, 21, 22, and/or 23 is replaced with \tilde{v}ⱼ and u_{random}, respectively. Namely, wⱼ is equal to \tilde{v}ⱼ, and v_{random} is equal to u_{random}. Also, the transformation codebook W in Equation 7 with has been replaced with \tilde{V}. That is, W is equal to \tilde{V}, where \tilde{V}=[\tilde{v}₁\tilde{v}₂\tilde{v}₃ . . . \tilde{v}_{D}], and \tilde{v}ⱼ is the is the j^{th} column vector of \tilde{V}.

In another embodiment of this disclosure, the tracking equation simultaneously used at both a base station and a mobile station for estimating <<R>>[T] at the time index T, which is used to derive a transformation codebook, is as shown in Equation 24 below:

<<R>>[T]=α<<R>>[T−1]+(1−α)\tilde{v}ⱼ[T]\tilde{v}ⱼ^{H}[T]γ+βu_{random}[T]u_{random}^{H}[T], [Eqn. 24]

where T=1, 2, 3 . . . is the updated tracking timing index. α is the forgetting factor, which is designed to track the mobility of mobile channel, β is the random factor, and γ is the parameter related SINR or CQI value. \tilde{v}ⱼ[t] is the best transmit antenna weight at a base station at the time index T, which is also the best reported precoding vector from a mobile station, based on the transformed codebook \tilde{V}. The generation and signaling of α and β are described in the following section and u_{random}[T]=v_{random}[T] is an complex random vector used in the tracking equation such as Equation 24 at the time index T, which is generated and described in the following sections.

With the special case of γ=1, <<R>>[T], which is applied to a base codebook to form a transformation codebook in Equation 24, can be simplified as shown in Equation 25 below:

<<R>>[T]=α<<R>>[T−1]+(1−α)\tilde{v}ⱼ[T]\tilde{v}ⱼ^{H}[T]+βu_{random}[T]u_{random}[T]. [Eqn. 25]

In another embodiment of the disclosure, the tracking equation simultaneously used at both a base station and a mobile station for estimating <<R>>[T] at the time index T, which is used to derive a transformation codebook, is shown in Equation 26 below:

<<R>>[T]=(1−α)<<R>>[T−1]+α\tilde{v}ⱼ[T]\tilde{v}ⱼ^{H}[T]γ+βu_{random}[T]u_{random}^{H}[T]. [Eqn. 26]

With the special case of γ=1, <<R>>[T], which is applied to a base codebook to form a transformation codebook in Equation 26, can be simplified as shown in Equation 27 below:

<<R>>[T]=(1−α)<<R>>[T−1]+α\tilde{v}ⱼ[T]\tilde{v}ⱼ^{H}[T]+βu_{random}[T]u_{random}^{H}[T]. [Eqn. 27]

As described in the previous section, α is the forgetting factor, which is designed to track the mobility of mobile channel, and β is the random factor, which is designed to avoid bias estimation of <<R>>. γ is the parameter related SINR or CQI value.

In another embodiment of this disclosure, the updated period (cycle) for α, β and γ in Equations 14, 15, 16, 17, 18, 20, 21, 22, 23, 24, 25, 26 and/or 27 can be the same or different. It is noted that α, β and γ are typically real numbers.

In another embodiment of this disclosure, a base station signals the parameter value of α (the forgetting factor) and β (the random factor) to a mobile station in Equations 14, 15, 16, 17, 18, 20, 21, 22, 23, 24, 25, 26 and/or 27. In particular embodiments, the range of the parameter value for α (the forgetting factor) and β (the random factor) is between 0 and 1.

FIG. 17 illustrates tables used by a base station to signal various values to a mobile station according to embodiments of this disclosure.

In another embodiment of this disclosure, a base station signals the parameter value of β (the forgetting factor) and β (the random factor) to a mobile station in order to enhance the tracking performance. For example, when a mobile station is under a high-mobility channel condition, a base station signals the mobile station to use a smaller value of α. In a particular embodiment, a 3-bit signaling method allows a base station to indicate or signal the values of both α and β to a mobile station in a wireless downlink communication. As an example, in one embodiment of this disclosure, a base station signals the value of the forgetting factor α using the 3-bit table 1701, namely <b2b1b0>. In another embodiment of this disclosure, a base station signals the value of the random factor β using the 3-bit table 1703, namely <b2b1b0>. In a further embodiment of this disclosure, a base station signals the value of the random factor γ using the 2-bit table 1705, namely <b1b0>.

The configuration of α, β, and γ can be signaled from the base station to the mobile station. Since the configuration of the algorithm does not need to change too often, the overhead can be quite small.

This section describes control signaling methods for pᵢ[T], w_{j[T], \tilde{v}}ⱼ[T], u_{random}[T] and/or v_{random}[T] used in Equations 14, 15, 16, 17, 18, 20, 21, 22, 23, 24, 25, 26 and/or 27. For the purpose of notation simplification, the control signaling method for pᵢ, wⱼ, \tilde{v}_{random} and/or u_{random} discussed in this section is typically referred at the time index T. For example, wⱼ is referred as wⱼ[T]. \tilde{v}ⱼ is referred as \tilde{v}ⱼ[T], u_{random} is referred as u_{random}[T] and so forth.

In another embodiment of this disclosure, as described in FIG. 15, a mobile station reports the index i for the preferred transmit antenna weight vector pᵢ and/or the index j for the preferred transmit antenna weight vector wⱼ to a base station. The best reported indexes of i and j are derived at the mobile station based on Equation 18 and Equation 8, respectively. The number of bits needed to report the best indexes of i and j is B, where D=2B, and D is the total number of column vectors of a base and/or fixed codebook P or a transformation and/or adaptive codebook W. For example, B=4 (bits) is needed if D=16 (column vectors) is used for a base codebook or transformation codebook.

In another embodiment of the disclosure, the vectors (wⱼ and/or v_{random}) that are used for updating the transmit covariance matrix estimation <<R>>[T] in Equations 14, 15, 16, 17, 18, 20, 21, 22, and/or 23 are selected from a codebook. The codebook can be specified and stored in the memory of a base station and a mobile station so that real-time generation of these vectors is not needed. In another embodiment of this disclosure, for example, a mobile station reports the index j for the preferred transmit th antenna weight vector wⱼ to a base station, where wⱼ is the j^{th} column vector of an adaptive codebook, a transformation codebook, and/or a fixed codebook (namely, W). It is noted that v_{random} is a complex random vector at the time index T and can be selected from a fixed codebook of random vectors, where the codebook of random vector is known to both a base station and a mobile station.

In another embodiment of the disclosure, the vectors (\tilde{v}ⱼ and/or u_{random}) that are used for updating the transmit covariance matrix estimation <<R>>[T] in Equations 24, 25, 26, and/or 27 are selected from a codebook. The codebook can be specified and stored in the memory of a base station and a mobile station so that real-time generation of these vectors is not needed. In another embodiment of this disclosure, for example, a mobile station reports the index j for the preferred transmit antenna weight vector \tilde{v}ⱼ to a base station, where \tilde{v}ⱼ is the j^{th} column vector of an adaptive codebook, a transformation codebook, and/or a fixed codebook (namely, \tilde{V}). It is noted that u_{random} is a complex random vector at the time index T and can be selected from a fixed codebook of random vectors, where the codebook of random vector is known to both a base station and a mobile station.

In another embodiment of the disclosure, the vectors (pᵢ and/or v_{random}) that are used for updating the transmit covariance matrix estimation <<R>>[T] in Equations 14, 15, 16, 17, 18, 20, 21, 22, and/or 23 are selected from a codebook. The codebook can be specified and stored in the memory of a base station and a mobile station so that real-time generation of these vectors is not needed. In another embodiment of this disclosure, for example, a mobile station reports the index i for the preferred transmit antenna weight vector pᵢ to a base station, where pᵢ is the i^{th} column of a base codebook and/or a fixed codebook (namely, P). It is noted that v_{random} is a complex random vector at the time index T and can be selected from a fixed codebook of random vectors, where the codebook of random vector is known to both the base station and the mobile station.

It is noted that these reports are needed anyway for closed-loop MIMO operation. In that sense, closed-loop transformation codebook tracking is achieved without any additional overhead.

In another embodiment of this disclosure, in order to increase the convergence speed, a preferred index of a vector or matrix can be additionally reported. The vector can be selected from a codebook of vectors. The vectors of the codebook can be randomly generated. For example, in at least one feedback report, a mobile station (MS) can generate a codebook with a number of random vectors/matrices, and inform the base station (BS) which one or multiple vectors/matrices out of the codebook that the MS prefers. The BS will also generate the same codebook in a synchronized fashion. The BS can then uses the feedback information to pick the preferred vectors/matrices that the MS prefers to update the estimate of the transmit covariance matrix. For example, in feedback period T, both the MS and the BS generate two random vectors. The MS feeds back the index of the preferred random vector that achieves fast convergence of R as v_{random}[T]. Both of the MS and the BS can update the transmit covariance matrix estimate <<R>>[T], which is applied to a base codebook to form a transformation codebook, as in Equation 28 below (which is the same as Equation 17):

<<R>>[T]=(1−α)<<R>>[T−1]+αwⱼ[T]wⱼ^{H}[T]+βv_{random}[T]v_{random}^{H}[T]. [Eqn. 28]

In another embodiment of the disclosure, the random vectors (v_{random}[T]) that are used for updating the transmit covariance matrix estimation <<R>>[T] are selected from a codebook. The codebook can be specified and stored in the memory of the BS and MS so that real-time generation of random vectors are not needed. At a time period T, both the MS and the BS select the same vector, denoted by v_{perturb}[T], to update the transmit covariance matrix estimation <<R>>[T], which is applied to a base codebook to form a transformation codebook, according to Equation 29 below:

<<R>>[T]=(1−α)<<R>>[T−1]+αwⱼ[T]wⱼ^{H}[T]+βv_{perturb}[T]v_{perturb}^{H}[T]. [Eqn. 29]

Alternatively, at a time period T, both the MS and the BS select the same vector, denoted by v_{perturb}[T], to update the transmit covariance matrix estimation <<R>>[T], which is applied to a base codebook to form a transformation codebook, according to Equation 30 below:

<<R>>[T]=α<<R>>[T−1]+(1−α)wⱼ[T]wⱼ^{H}[T]+βv_{perturb}[T]v_{perturb}^{H}[T]. [Eqn. 30]

For a low overhead implementation, the BS and the MS can use the same algorithm to select the index of the vector from the same codebook. One of ordinary skill in the art would recognize that there are many ways to achieve this purpose. For example, the index can be derived as a function of a frame number, BS identification, MS identification, and a pseudo random number generator. Alternatively, in order to increase the speed of convergence, the MS may report the index of the selected vector that achieves fast convergence of the transmit covariance matrix estimation to the BS. It is noted that v_{perturb}[T] is a complex random vector.

Of course, one of ordinary skill in the art would recognize that the codebook can vary over time or for different base stations or mobile stations.

Although embodiments of this disclosure are described with reference to Equations 28, 29 and/or 30 as examples, one of ordinary skill in the art would recognize that the embodiments are applicable to other methods of updating the transmit covariance matrix estimation.

In another embodiment of this disclosure, the updated period (cycle) for pᵢ[T], wⱼ[T], \tilde{v}ⱼ[T], u_{random}[T], v_{perturb}[T] and v_{random}[T] in Equations 14, 15, 16, 17, 18, 20, 21, 22, 23, 24, 25, 26, 27, 28, 29, and/or 30 can be the same or different.

This section describes the generation procedure of the complex random vectors (v_{random}[T] and u_{random}[T]) used in the tracking Equations 14, 15, 16, 17, 18, 20, 21, 22, 23, 24, 25, 26, 27, 28, 29 and/or 30. For the purpose of notation simplification, v_{random}, and/or u_{random} discussed in this section is typically referred at the time index T. Namely, v_{random}[T] is referred as v_{random} and u_{random} [T] is referred as u_{random}.

In another embodiment of the disclosure, in order to increase the convergence speed of <<R>>, a complex random vector of v_{random} or u_{random} can be additionally reported. The vector can be selected from a codebook of random vectors. The codebook of random vectors can be fixed and is known to both a base station and a mobile station. In a particular embodiment, a mobile station reports the best selected index of random vectors within the codebook to a base station to optimize the convergence speed.

In another embodiment of this disclosure, v_{random} or u_{random} is a complex random vector, which is simultaneously generated at both a base station and a mobile station in a synchronized manner. It is noted that v_{random} or u_{random} is designed to avoid bias estimation of <<R>>. For example, v_{random} or u_{random} is generated based on a binary pseudorandom sequence (BPRS) produced by a Linear Feedback Shift Register (LFSR).

In another embodiment of this disclosure, v_{random} or u_{random} is generated based on a binary pseudorandom sequence (BPRS) produced, for example, by a Linear Feedback Shift Register (LFSR) with the polynomial generator as shown in Equation 31 below:

g(x)=g₀x^{L}+g₁x^{L-1}+ . . . +g_{L-1}x+g_{L}, [Eqn. 31]

where L is the length of the LFSR. One example of such a polynomial generator is g(x)=x16+x15+x2+1. In a particular embodiment, the BPRS generator is initialized by the seed b15b14b13b12b11 . . . b2b1b0, which can be derived based on a mobile station ID or STID.

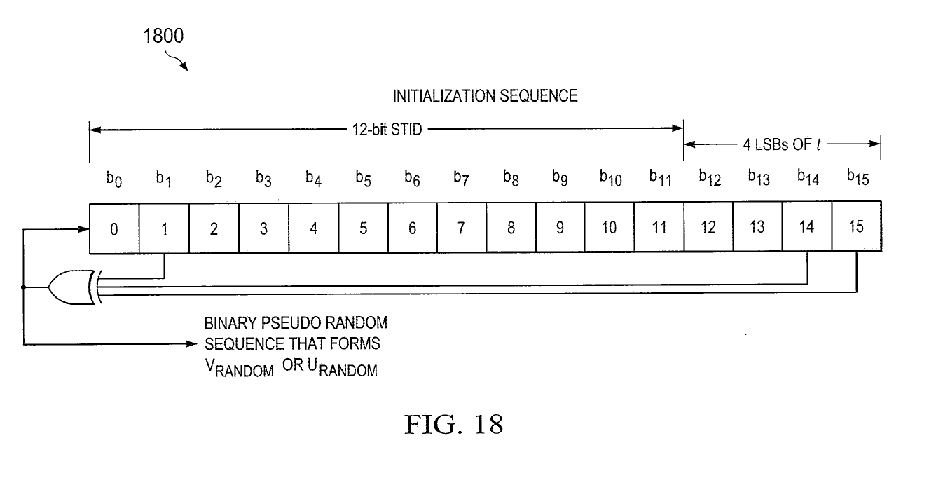

FIG. 18 illustrates a binary pseudorandom sequence generator 1800 according to an embodiment of this disclosure.

In a particular embodiment, the binary pseudorandom sequence generator 1800 is initialized in each feedback period by the seed b15b14b13b12b11 . . . b2b1b0. The 12 lowest significant bits (LSBs) of the seed are an MS's STID. The 4 most significant bits (MSBs) of the seed are the 4 LSBs of the feedback period index T as shown in FIG. 18.

In a particular embodiment, the random vector, v_{random} or u_{random} is generated' at the beginning of feedback period T when both the BS and the MS initialize the LFSR with the same seed, b15b14b13b12b11 . . . b2b1b0. The 12 MSBs of the seed are an MS's STID. The 4 LSBs of the seed are the 4 LSBs of the feedback period index T.

Each entry of the random vector v_{random} or u_{random} is quantized into M=8 bits, and there are N=8 entries in the random vector v_{random or u}_{random}. Both the BS and the MS clock the LFSR M×N=8×8=64 times with the first 8 binary output of the LFSR forming the first entry of the vector, the second 8 binary output of the LFSR forming the second entry of the vector, and so forth. The generated vector is denoted by v_{random,unnormalized} or u_{random,unnormalized}. To form an entry in the random vector, the first 4 bits form the real part of the entry, and the last 4 bits form the imaginary part of the entry. The signage of the real part or the imaginary part is indicated by the first bit of each group of 4 bits.

If ∥c_{random,unnormalized}∥2=0 or ∥u_{random,unnormalized}∥2=0, each entry of the random vector v_{random} or u_{random} is again quantized into M=8 bits. Otherwise, the random vector is normalized by dividing the generated random vector by its norm as follows:

v_{random}=v_{random,unnormalized}/∥v_{random,unnormalized}∥ or

u_{random}=u_{random,unnormalized}/∥u_{random,unnormalized}∥

Since both the BS and the MS follow the same procedure, no signaling of the random vector v_{random} or u_{random} is needed.

One of ordinary skill in the art would recognize that the embodiments of this disclosure can be used to synchronize the generation of multiple random vectors at the BS and the MS. The embodiments also can be readily extended to other precision and other number of antennas by different configurations of M and N. One of ordinary skill in the art also would recognize that it is straightforward to extend the embodiments to synchronize the generation of one or multiple random matrices at the BS and the MS.

Also note that for consistent performance in each step of the tracking, the random vectors are normalized so that the size of each adaptation step is the same. However, normalization typically requires division operation, which is often not preferred due to its complexity. One alternative is to skip the normalization step. For example, one embodiment of achieving synchronized generation of a random vector includes both the BS and the MS initializing the LFSR with the same seed at the same time (e.g., the beginning of every superframe (e.g., 20 ms) or the beginning of every multi-superframe period (the length of the period can be configurable)). The seed can be derived from a frame number, a base station ID, a mobile station ID, or some other information.

Assuming each entry of a random vector v_{random} or u_{random} is quantized into M bits, and there are N entries in the random vector v_{random} or u_{random}. Both the BS and the MS clock the LFSR M×N times with the first M binary output of the LFSR forming the first entry of the vector, the second M binary output of the LFSR forming the second entry of the vector, and so forth. The generated vector is denoted by or v_{random,unnormalized} or u_{random,unnormalized}. To form an entry in the random vector, for example, 8 bits of binary output (M=8) are taken. The first 4 bits form the real part of the entry and the last 4 bits form the imaginary part of the entry, assuming the entry is a complex number. The signage of the real part or the imaginary part is indicated by the first bit of each group of 4 bits.

If the required number of random vector generated has been reached, the operation stops. Otherwise, both the BS and the MS again clock the LFSR M×N times with the first M binary output of the LFSR forming the first entry of the vector, the second M binary output of the LFSR forming the second entry of the vector, and so forth.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A wireless communications network comprising a plurality of base stations, each one of said base stations capable of wireless communications with a plurality of subscriber stations, at least one of said plurality of base stations comprising:
a receiver configured to receive a precoding vector index (PVI) from a subscriber station;
a controller configured to:
update a transmit covariance matrix using the precoding vector index, and
transform a codebook using the updated transmit covariance matrix; and
a transmitter configured to perform transmit beamforming to the subscriber station using the transformed codebook.

2. A network in accordance with claim 1 wherein the transmit covariance matrix is a long-term average, normalized transmit covariance matrix.

3. A network in accordance with claim 1 wherein updating the transmit covariance matrix by least one of said plurality of base stations comprises tracking the transmit covariance matrix using the following function:
<<\hat{R}>>=f(α,β,dₘₐₓ,p_{d}_{ₘₐₓ},v_{random})
where <<\hat{R}>> is the updated transmit covariance matrix, α is a forgetting factor designed to track a mobility of a channel, β is random factor designed to avoid a bias effect on an estimation of <<\hat{R}>>, p_{d}_{ₘₐₓ} is the PVI received from the subscriber station, and v_{random} is a random vector simultaneously generated at both the base station and the subscriber station in a synchronized manner.

4. A network in accordance with claim 1 wherein updating the transmit covariance matrix by least one of said plurality of base stations comprises tracking and estimating the transmit covariance matrix using the following equation:
<<\hat{R}>>[T]=α<<\hat{R}>>[T−1]+(1−α)p_{d}_{ₘₐₓ}[T]p_{d}_{ₘₐₓ}^{H}[T]+βv_{random}[T]v_{random}^{H}[T],T=1, 2, 3 . . . ,
where <<\hat{R}>> is the updated transmit covariance matrix, α is a forgetting factor designed to track a mobility of a channel, β is random factor designed to avoid a bias effect on an estimation of <<\hat{R}>>, p_{d}_{ₘₐₓ} is the PVI received from the subscriber station, and v_{random} is a random vector simultaneously generated at both the base station and the subscriber station in a synchronized manner.

5. A network in accordance with claim 3 wherein v_{random} is generated using a same random seed at both the base station and the subscriber station.

6. A network in accordance with claim 4 wherein v_{random} is generated using a same random seed at both the base station and the subscriber station.

7. A network in accordance with claim 3 wherein an update period or cycle for p_{d}_{ₘₐₓ} is the same as or different from an update period or cycle for v_{random.}

8. A network in accordance with claim 4 wherein an update period or cycle for p_{d}_{ₘₐₓ} is the same as or different from an update period or cycle for v_{random}.

9. A network in accordance with claim 1 wherein the controller is further configured to normalize the transmit covariance matrix before using the transmit covariance matrix to transform the codebook.

10. A base station comprising:
a receiver configured to receive a precoding vector index (PVI) from a subscriber station;
a controller configured to:
update a transmit covariance matrix using the precoding vector index, and
transform a codebook using the updated transmit covariance matrix; and
a transmitter configured to perform transmit beamforming to the subscriber station using the transformed codebook.

11. A method of operating a base station, the method comprising:
receiving a precoding vector index (PVI) from a subscriber station;
updating a transmit covariance matrix using the precoding vector index;
transforming a codebook using the updated transmit covariance matrix; and
performing transmit beamforming to the subscriber station using the transformed codebook.

12. A subscriber station comprising:
a receiver configured to receive a pilot or channel sounding signal from a base station;
a controller configured to determine a precoding vector index (PVI) based at least partly upon the received pilot or channel sounding signal; and
a transmitter configured to transmit the precoding vector index to the base station.

13. A subscriber station in accordance with claim 12 wherein upon receiving the precoding vector index, the base station is configured to:
update a transmit covariance matrix using the precoding vector index;
transform a codebook using the updated transmit covariance matrix; and
perform transmit beamforming to the subscriber station using the transformed codebook.

14. A subscriber station in accordance with claim 13 wherein the transmit covariance matrix is a long-term average, normalized transmit covariance matrix.

15. A subscriber station in accordance with claim 13 wherein updating the transmit covariance matrix by the base station comprises tracking the transmit covariance matrix using the following function:
<<\hat{R}>>=f(α,β,dₘₐₓ,p_{d}_{ₘₐₓ},v_{random}),
where <<\hat{R}>> is the updated transmit covariance matrix, α is a forgetting factor designed to track a mobility of a channel, β is random factor designed to avoid a bias effect on an estimation of <<\hat{R}>>, p_{d}_{ₘₐₓ} is the PVI received from the subscriber station, and v_{random} is a random vector simultaneously generated at both the base station and the subscriber station in a synchronized manner.

16. A subscriber station in accordance with claim 13 wherein updating the transmit covariance matrix by the base station comprises tracking and estimating the transmit covariance matrix using the following equation:
<<\hat{R}>>[T]=α<<R>>[T−1]+(1−α)p_{d}_{ₘₐₓ}[T]p_{d}_{ₘₐₓ}[T]+βv_{random}[T]v_{random}^{H}[T],T=1, 2, 3 . . . ,
where <<\hat{R}>> is the updated transmit covariance matrix, α is a forgetting factor designed to track a mobility of a channel, β is random factor designed to avoid a bias effect on an estimation of <<\hat{R}>>, p_{d}_{ₘₐₓ} is the PVI received from the subscriber station, and v_{random} is a random vector simultaneously generated at both the base station and the subscriber station in a synchronized manner.

17. A subscriber station in accordance with claim 15 wherein v_{random} is generated using a same random seed at both the base station and the subscriber station.

18. A subscriber station in accordance with claim 16 wherein v_{random} is generated using a same random seed at both the base station and the subscriber station.

19. A subscriber station in accordance with claim 15 wherein an update period or cycle for p_{d}_{ₘₐₓ} is the same as or different from an update period or cycle for v_{random}.

20. A subscriber station in accordance with claim 16 wherein an update period or cycle for p_{d}_{ₘₐₓ} is the same as or different from an update period or cycle for v_{random}.
